(19) United States
(12) Patent Application Publication
(10) Pub. No.: US 2016/0063547 A1
(43) Pub. Date: Mar. 3, 2016

(54) METHOD AND SYSTEM FOR MAKING TARGETED OFFERS

(71) Applicant: MASTERCARD INTERNATIONAL INCORPORATED, Purchase, NY (US)

(72) Inventors: Debashis Ghosh, Charlotte (NC); Randall K. Shuken, Westport, CT (US); Sebastian Shuken, Westport, CT (US)

(21) Appl. No.: 14/471,195

(22) Filed: Aug. 28, 2014

(51) Int. Cl. G06Q 30/02

(52) U.S. Cl. CPC G06Q 30/0255; G06Q 50/01

(57) ABSTRACT

A method for making a targeted offer by an entity to an audience of potential acceptors using a media streaming service is provided. The method includes retrieving information including purchasing and payment activity information attributable to the audience of potential acceptors; retrieving information including social media information indicative of one or more media listening or viewing patterns, interests or preferences of the audience of potential acceptors; correlating the information to generate one or more predictive behavioral models; identifying activities and characteristics attributable to the audience of potential acceptors; and conveying to the entity the activities and characteristics attributable to the audience of potential acceptors, to enable the entity to make a targeted offer to the audience of potential acceptors. A system for making a targeted offer by an entity to an audience of potential acceptors is also provided.

### BACKGROUND OF THE DISCLOSURE

1. Field of the Disclosure

The present disclosure relates to a method and a system for making targeted offers to an audience of potential acceptors. More particularly, the present disclosure relates to a method and a system for making targeted offers to an audience of potential acceptors using purchasing and payment activity information attributable to the audience of potential acceptors and social media information indicative of media listening or viewing patterns, interests or preferences of the audience of potential acceptors.

2. Description of the Related Art

Marketing expenses are often one of the largest cost categories for an organization. Marketing difficulties in effectively capturing and reaching the correct population of consumers is an industry wide problem, regardless of goods or services offered. In an attempt to overcome these difficulties, entities often engage in various advertising techniques to a broad audience hoping to reach interested consumers. However, such broad advertising techniques are often ignored by consumers or fail to reach the intended audience.

Information on consumers or potential purchasers can be very important to sellers of goods and services. Advertisers benefit from having detailed information about buying interests or capacities of potential purchasers of goods or services. If an advertiser, for instance, can identify and selectively advertise to those potential purchasers who fit a profile of probable purchasers of the advertiser's goods or services, the advertiser can reduce advertising costs by advertising directly to those potential purchasers. In other words, if the advertiser has both information about potential purchasers and more targeted access for its messages, it can achieve more purchasers/customers for the same amount of money. Useful financial and demographic information for such a strategy includes a potential purchaser's financial status, age, residence, and interests in various goods and services.

If an advertiser has access to such financial and demographic information about a potential purchaser, the advertiser can selectively market to the more promising purchasers for a decreased expense per sales transaction. The money saved by the advertiser can, potentially, be used to reduce the price of the good or service to the purchaser. Instead of advertising to the masses of potential purchasers, the advertiser can concentrate on specific potential purchasers who may be likely to buy a specific good or service and offer favorable pricing.

Using relevant data, consumer activities and characteristics typically provide an effective form of targeted marketing by creating a shopping experience that is personalized and relevant to the consumer. However, targeted marketing systems are often limited to accessing only a specific set of data that provides less than a holistic view of a consumer's spending habits and preferences.

Businesses and merchants are constantly seeking ways to operate in a sales environment where they are able to deliver advertising messages and offers to their target audience at the opportune time. For many, the best time for reaching potential consumers is at a time when the consumer is online website browsing. At other times, the most ideal scenario for a consumer to receive their advertisements and offers is when they are physically in the sales area or approaching the sales area. In such instances, there is a need to provide targeted advertising messages and offers to consumers at the right place, to enhance the sale of goods and services to potential customers.

Therefore, a need exists for a system that can provide a more effective form of targeted marketing by creating a shopping experience that is more personalized and relevant to the consumer. A more holistic view of a consumer's personal circumstances, including spending habits and online media listening or viewing patterns, interests or preferences, is needed for effective targeted marketing. Further, a need exists for a system that can analyze a customer's personal circumstances and identify customer activities and circumstances that may represent an opportunity for a merchant to offer products or services to the customer, that are specifically tailored to the customer's upcoming need or desire and communicate the offers to the customer.

### SUMMARY OF THE DISCLOSURE

The present disclosure relates to a method and a system for making a targeted offer by an entity to an audience of potential acceptors, specifically for the entity associating or otherwise partnering with a financial transaction processing entity, to identify ideal consumers for marketing purposes through the generation of predictive behavioral models that are based upon purchasing and payment activity information and social media information attributable to the audience of potential acceptors, and to enable the entity to make a targeted offer to the audience of potential acceptors.

The present disclosure also provides a method for making a targeted offer by an entity to an audience of potential acceptors using a media streaming service. The method comprises: retrieving, from one or more databases, a first set of information including purchasing and payment activity information attributable to the audience of potential acceptors; retrieving from the one or more databases, a second set of information including social media information indicative of one or more media listening or viewing patterns, interests or preferences of the audience of potential acceptors; correlating the first set of information with the second set of information to generate one or more predictive behavioral models; identifying activities and characteristics attributable to the audience of potential acceptors based on the one or more predictive behavioral models; and conveying to the entity the activities and characteristics attributable to the audience of potential acceptors based on the one or more predictive behavioral models, to enable the entity to make a targeted offer to the audience of potential acceptors using the media streaming service.

The present disclosure further provides a system for making a targeted offer by an entity to an audience of potential acceptors using a media streaming service. The system comprises: one or more databases configured to store a first set of information including purchasing and payment activity information attributable to the audience of potential acceptors; and one or more databases configured to store a second set of information including social media information indicative of one or more media listening or viewing patterns, interests or preferences of the audience of potential acceptors. The system also includes a processor configured to: correlate the first set of information with the second set of information to generate one or more predictive behavioral models; and identify activities and characteristics attributable to the audience of potential acceptors based on the one or more predictive behavioral models. The system further includes a device for conveying to the entity the activities and characteristics attributable to the audience of potential acceptors based on the one or more predictive behavioral models, to enable the entity to make a targeted offer to the audience of potential acceptors using the media streaming service.

The present disclosure still further provides a method for generating one or more predictive behavioral models. The method comprises: retrieving, from one or more databases, a first set of information including purchasing and payment activity information attributable to the audience of potential acceptors; retrieving from the one or more databases, a second set of information including social media information indicative of one or more media listening or viewing patterns, interests or preferences of the audience of potential acceptors; analyzing the first set of information and the second set of information to determine behavioral information of the audience of potential acceptors; extracting information related to an intent of the audience of potential acceptors from the behavioral information; and generating one or more predictive behavioral models based on the behavioral information and intent of the audience of potential acceptors with the audience of potential acceptors having a propensity to carry out certain activities based on the one or more predictive behavioral models.

These and other systems, methods, objects, features, and advantages of the present disclosure will be apparent to those skilled in the art from the following detailed description of the embodiments and the drawings.

### BRIEF DESCRIPTION OF THE DRAWINGS

FIG. 1 is a block diagram illustrating a high-level view of system architecture of a financial transaction processing system in accordance with exemplary embodiments of the present disclosure.

FIG. 2 illustrates a data warehouse shown in FIG. 1 that is a central repository of data which is created by storing certain transaction data from transactions occurring within four party payment card system of FIG. 1.

FIG. 3 shows illustrative information types used in the systems and the methods of this disclosure.

FIG. 4 illustrates a high-level view of social media data mining analysis in the context of a network of users and social media sources in accordance with exemplary embodiments of this disclosure.

FIG. 5 illustrates a detailed view of a server used in social media data mining analysis in accordance with exemplary embodiments of this disclosure.

FIG. 6 illustrates a method for social media data mining in accordance with exemplary embodiments of this disclosure.

FIG. 7 illustrates an exemplary dataset for the storing, reviewing, and/or analyzing of information used in the systems and the methods of this disclosure.

FIG. 8 is a flow chart illustrating a method for generating predictive behavioral models in accordance with exemplary embodiments of this disclosure.

FIG. 9 is a block diagram illustrating a method for making a targeted offer by a merchant to an audience of potential acceptors in accordance with exemplary embodiments of this disclosure.

FIG. 10 shows a block diagram of a data processing system that can be used in social media data mining in accordance with exemplary embodiments of this disclosure.

A component or a feature that is common to more than one figure is indicated with the same reference number in each figure.

### DESCRIPTION OF THE EMBODIMENTS

Embodiments of the present disclosure can now be described more fully hereinafter with reference to the accompanying drawings, in which some, but not all, embodiments of this disclosure are shown. Indeed, this disclosure can be embodied in many different forms and should not be construed as limited to the embodiments set forth herein. Rather, these embodiments are provided so that this disclosure satisfies applicable legal requirements. Like numbers refer to like elements throughout.

As used herein, entities can include one or more persons, organizations, businesses, institutions and/or other entities, including but not limited to, financial institutions, and services providers, that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, “social media” refers to any type of electronically-stored information that users send or make available to other users for the purpose of interacting with other users in a social context. Such media can include directed messages, status messages, broadcast messages, audio files, image files and video files. Reference in this disclosure to “social media websites” should be understood to refer to any website that facilitates the exchange of social media between users. Examples of such websites include social networking websites such as FACEBOOK and LINKEDIN, and microblogging websites such as TWITTER. Social media also refers to newspapers and magazines.

As used herein, “media streaming service” refers to any type of service that provides streaming media programming to users, in particular, streaming audio or video programming. The media streaming service can be used to provide audio and video content alone or simultaneously to a user or device of a user, without interrupting a flow of programming. Illustrative media streaming service providers include, for example, PANDORA, SLACKER, SPOTIFY, iTUNES, iHEARTRADIO, and the like.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies, such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the disclosure.

Thus, apparatus, systems, methods and computer program products are herein disclosed to generate predictive behavioral models, to identify, analyze, extract and correlate consumer activities and characteristics that represent an opportunity to target offer products or services to the consumer, and also an opportunity for predicting consumer behavior and intent. Embodiments of the present disclosure will leverage the information available to identify data that is indicative of a consumer's activities and characteristics, and to predict consumer behavior and intent based on those activities and characteristics. Such activities and characteristics can include, but are not limited to, spending behavior, media listening and viewing behavior, age, gender, geography, and the like. By identifying and analyzing consumer activities and characteristics based on predictive behavioral models, one can offer products and services that are relevant to the consumer's needs.

The method and system of this disclosure take advantage of the fact that it is now common for people to maintain profiles on social networks such as MySpace, Facebook, Myxer, and many others which contain information about their interests, hobbies, and specifically their musical and artist preferences. The information is presented in many different forms, and can include simple lists of favorite artists/musical genres, links to web pages that feature particular artists/genres, widgets that feature particular artists or genres, or plaintext comments or other descriptions that express a like or dislike of particular forms of music.

These profiles can be manually edited by users, when, for example, a user crafts a specific profile section describing their “favorite musical artists”. In other embodiments, they can be automatically created by a service such as a social network. An example of an automatically-created profile is a user profile on the website Myxer.com. Each user has a profile page that is created and accessible via a web browser that contains, among other things, a list of recently downloaded ringtones, MP3s, and other digital content for a user. These recently downloaded files may be considered media that the user has a positive preference for or “likes”. Another example is on Facebook, where if a user expresses a preference for a particular musical genre or artist through an online action (such as pressing a ‘like’ button provided by the Facebook API), information about that preference can be automatically made visible in their Facebook profile, regardless of where on the web the user expressed that preference.

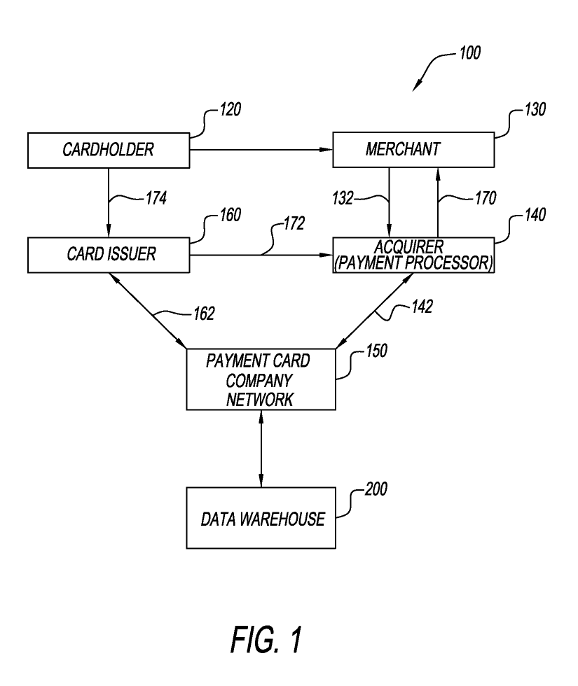

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring in four party payment card system 100. According to another embodiment, data warehouse 200 stores, for example, the date, time, amount, location, merchant code, and merchant category for every transaction occurring in payment card network 150.

In yet another embodiment, data warehouse 200 stores, reviews, and/or analyzes information used in: (i) constructing one or more definitions of payment card transactions and one or more payment card holder lists to identify payment card holder overlap; (ii) constructing one or more definitions of payment card transactions, one or more definitions of media listening or viewing patterns, interests or preferences, and one or more payment card holder lists to identify payment card holder overlap; (iii) creating one or more groupings of payment card transactions and media listening or viewing patterns, interests or preferences based on the payment card holder overlap; and (iv) creating one or more datasets to store information relating to the one or more groupings of payment card transactions and media listening or viewing patterns, interests or preferences.

In still another embodiment, data warehouse 200 stores, reviews, and/or analyzes information used in creating one or more datasets to store information relating to the one or more groupings of payment card transactions and media listening or viewing patterns, interests or preferences.

In another embodiment, data warehouse 200 stores, reviews, and/or analyzes information used in developing logic for creating one or more groupings payment card transactions and media listening or viewing patterns, interests or preferences based on the payment card holder overlap, and applying the logic to a universe of payment card transactions and media listening or viewing patterns, interests or preferences to create associations between the payment card transactions and the media listening or viewing patterns, interests or preferences.

In still another embodiment, data warehouse 200 stores, reviews, and/or analyzes information used in quantifying the strength of the one or more associations between the one or more payment card holders and the one or more groupings of payment card transactions and media listening or viewing patterns, interests or preferences.

In another embodiment, data warehouse 200 stores, reviews, and/or analyzes information, with respect to the one or more associations amongst the one or more payment card holders, the one or more groupings of payment card transactions and the media listening or viewing patterns, interests or preferences, used in assigning attributes to the one or more payment card holders, the one or more groupings of payment card transactions and media listening or viewing patterns, interests or preferences. The attributes are selected from the group consisting of one or more of confidence, time, and frequency.

In yet another embodiment, data warehouse 200 stores, reviews, and/or analyzes information used in identifying one or more payment card holders, one or more groupings of payment card transactions, and media listening or viewing patterns, interests or preferences, and strength of the one or more associations between the one or more payment card holders and the one or more groupings of payment card transactions and media listening or viewing patterns, interests or preferences.

In still another embodiment, data warehouse 200 stores, reviews, and/or analyzes information used in targeting information including at least one or more suggestions or recommendations for payment card holder spending or purchasing activity at a geolocation, based on the one or more associations between the one or more payment card holders and the one or more groupings of payment card transactions and media listening or viewing patterns, interests or preferences.

In another embodiment, data warehouse 200 aggregates the information by merchant and/or category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

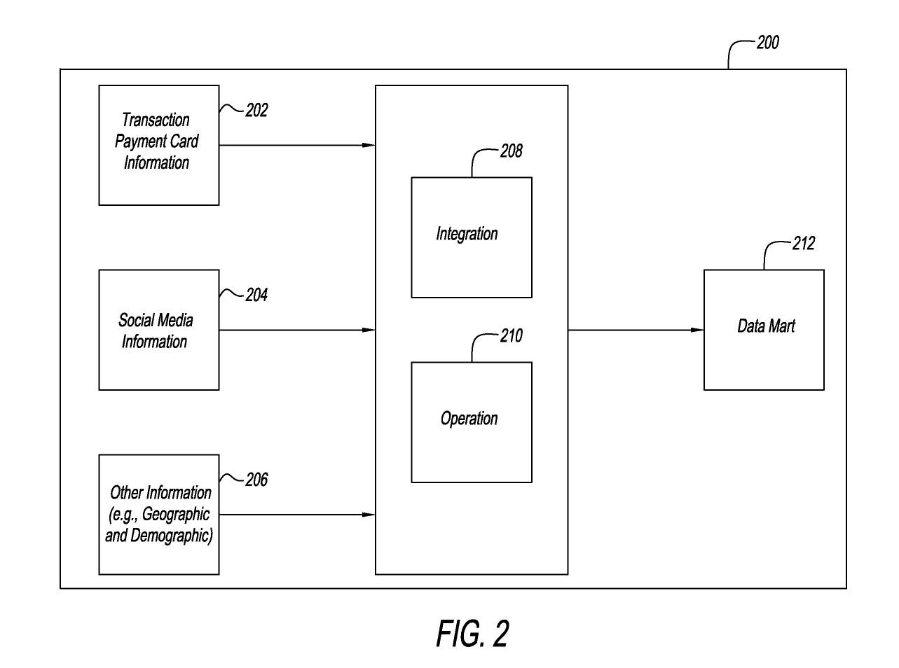

FIG. 2 illustrates an exemplary data warehouse 200 (the same data warehouse 200 in FIG. 1) for reporting and data analysis, including the storing, reviewing, and/or analyzing of information, for the various purposes described above. The data warehouse 200 can contain a plurality of information entries (e.g., entries 202, 204, and 206).

The payment card transaction information 202 can contain, for example, purchasing and payment activities attributable to purchasers (e.g., payment card holders), that is aggregated by merchant and/or category and/or location in the data warehouse 200. The social media information 204 includes, for example, media listening or viewing patterns, interests or preferences of the audience of potential acceptors and the like. Other information 206 can include demographic or geographic or other suitable information that can be useful in constructing one or more definitions of one or more definitions of payment card transactions, one or more definitions of media listening or viewing patterns, interests or preferences, and one or more payment card holder lists by media listening or viewing patterns, interests or preferences, to identify payment card holder overlap, and creating one or more groupings of payment card transactions and media listening or viewing patterns, interests or preferences, based on the payment card holder overlap.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by merchant and/or category and/or location at 208, and correlated with social media information at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems may be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

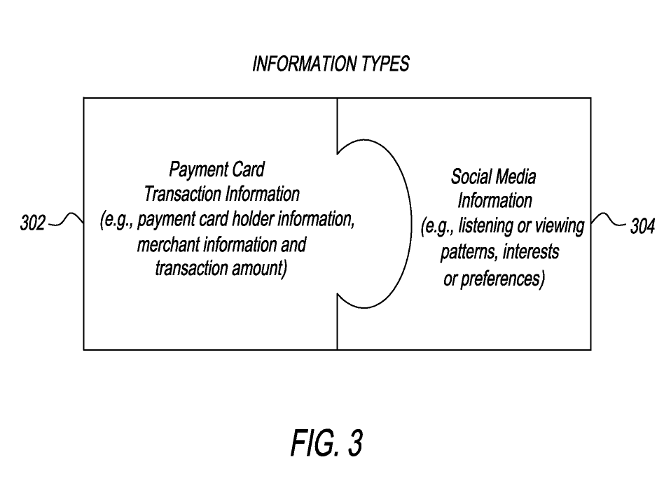

In accordance with the method of this disclosure, information that is stored in one or more databases can be retrieved (e.g., by a processor). FIG. 3 shows illustrative information types used in the systems and methods of this disclosure.

The information can contain, for example, a first set of information including payment card transaction information 302. Illustrative first set of information can include, for example, transaction date and time, payment card holder information, merchant information and transaction amount. In particular, the payment card transaction information can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information. Information for inclusion in the first set of information can be obtained, for example, from payment card companies known as MasterCard®, Visa®, American Express®, and the like (part of the payment card company network 150 in FIG. 1).

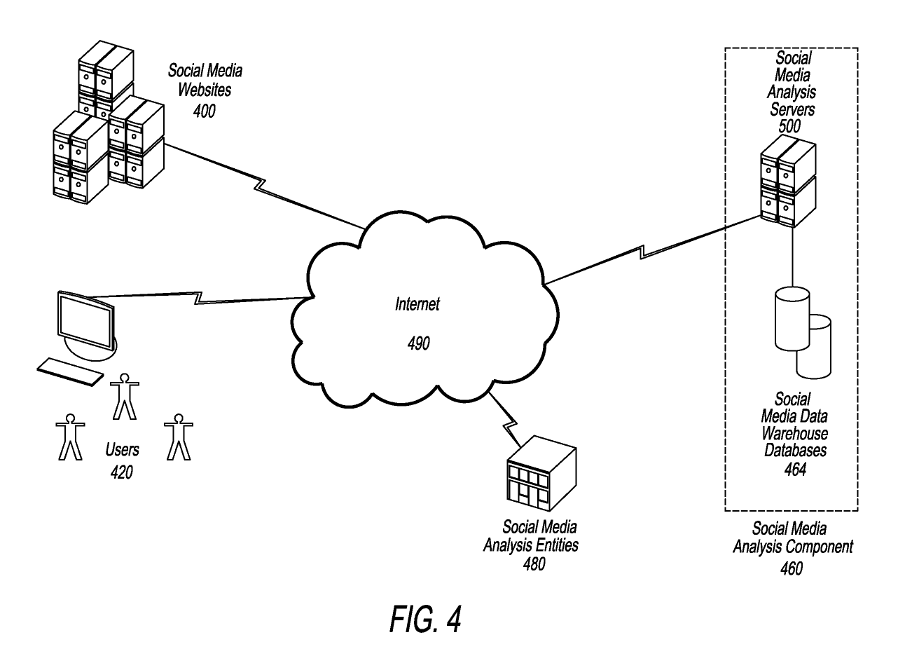

The information can also contain, for example, a second set of information including social media information 304. Illustrative second set information can include, for example, social media information indicative of one or more media listening or viewing patterns, interests or preferences of the audience of potential acceptors. Illustrative social media information indicative of one or more media listening or viewing patterns, interests or preferences of the audience of potential acceptors includes, for example, information concerning the merchant that is retrieved from TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines. Preferred processes for social media data mining to obtain information regarding consumer listening or viewing patterns, interests or preferences are described herein. Illustrative embodiments of such processes for social media data mining to obtain information indicative of one or more media listening or viewing patterns, interests or preferences are shown in FIGS. 4-6.

Various embodiments of the systems and methods disclosed herein collect social media gathered from a plurality of social media websites 400 (FIG. 4) and provide various interfaces and reporting functions to allow end users to obtain information regarding consumer listening or viewing patterns, interests or preferences. FIG. 4 illustrates a high-level view of a social media analysis process in the context of a network of users and social media sources. A plurality of users 420 interact with one another via a plurality of social media websites 400 such as, for example, social networking and microblogging websites, via internet 490.

A social media analysis component 460 includes one or more social media analysis servers 500 that collect social media from social media websites 400 and store such social media in one or more social media data warehouse databases 464. The social media analysis servers 500 provide one or more user interfaces that allow social media analysis entities (e.g., a payment card company) 480 to view and analyze aggregated social media stored on the social media data warehouse databases 464. Such entities can include any type of business that has an interest in the content of social media. In one embodiment, the social media analysis component 460 and the social media analysis entities 480 can be in a single organization. In another embodiment, the social media analysis component 460 and the social media analysis entities 480 can be in two separate organizations.

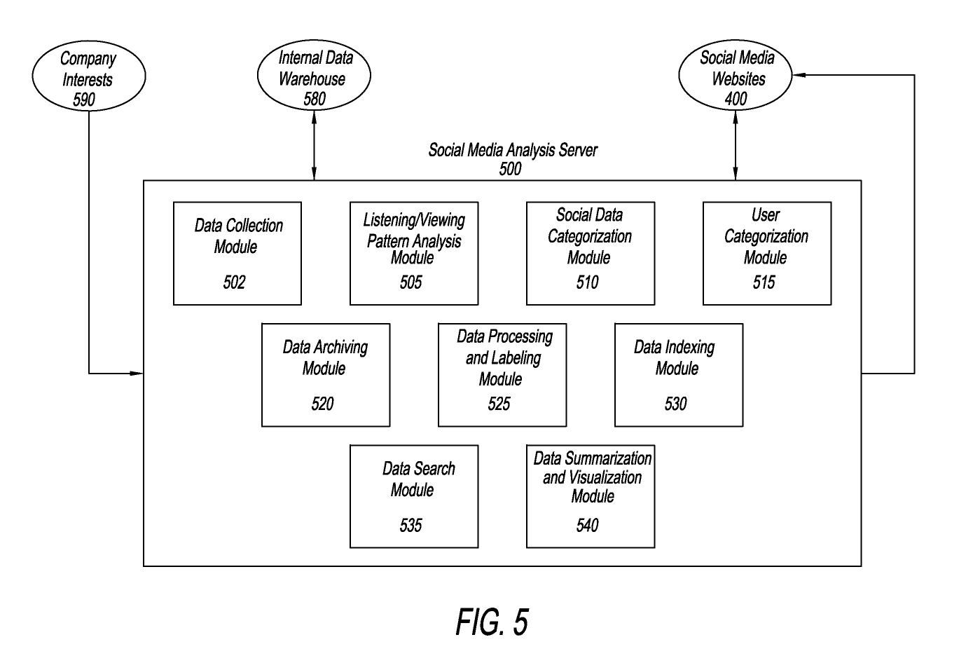

FIG. 5 illustrates a more detailed view of a social media analysis server 500. In the illustrated embodiment, social media analysis server 500 collects social media from various social media websites 400, stores the collected media in an internal data warehouse 580 and provides access to the warehoused social media to one or more entities.

The social media analysis server 500 includes a number of modules that provide various functions related to social media collection analysis. The social media analysis server 500 includes a data collection module 502 that collects social media from social media websites 400. The data collection module 502 collects social media that relates to company interests 590, such as, for example, posts that provide information indicative of one or more user listening or viewing patterns, interests or preferences, posts that reference the company by name, posts that relate to specific topics, and/or posts that relate to specific users.

The social media analysis server 500 includes a listening/viewing pattern analysis module 505 that attempts to determine the nature of listening or viewing patterns, interests or preferences, expressed by users in social media posts. The social media analysis server 500 includes a social data categorization module 510 that categorizes social media postings by, for example, topic, company, listening or viewing patterns, interests or preferences. The social media analysis server 500 includes user categorization module 515 that categorizes users, for example, by various demographic characteristics or usage patterns. The social media analysis server 500 includes a data archiving module 520 that archives collected social media in the internal data warehouse 580 in association with user profiles and social connections of users relating to the social media. The social media analysis server 500 includes a data processing and labeling module 525 that labels social media data with various tags, such as categories determined by the social data categorization module 510 and the user categorization module 515. The social media analysis server 500 includes a data indexing module 530 that indexes archived social media by one or more properties. Such properties can include, for example, key words, user listening or viewing patterns, interests or preferences, or user demographics. The social media analysis server 500 includes a data search module 540 that provides facilities allowing users to search archived social media using search criteria such as, for example, one or more keywords or key phrases.

The social media analysis server 500 includes a data summarization and visualization module 540 that allows social data analysis entities to query social media archived in the internal data warehouse 580. The data summarization and visualization module 540 uses the aggregated social media, along with associated archived user profile information and user social connections to support high-level listening or viewing patterns, interests or preferences through data mining. The output of data mining and analysis is stored on a database and indexed by the data archiving module along with archived posts, user profiles, and user social connection to support expanded search capabilities. The summarization and visualization module 540 provides various views into the aggregated social media. Such visualized information can be used to better understand listening or viewing patterns, interests or preferences by mining the social media data.

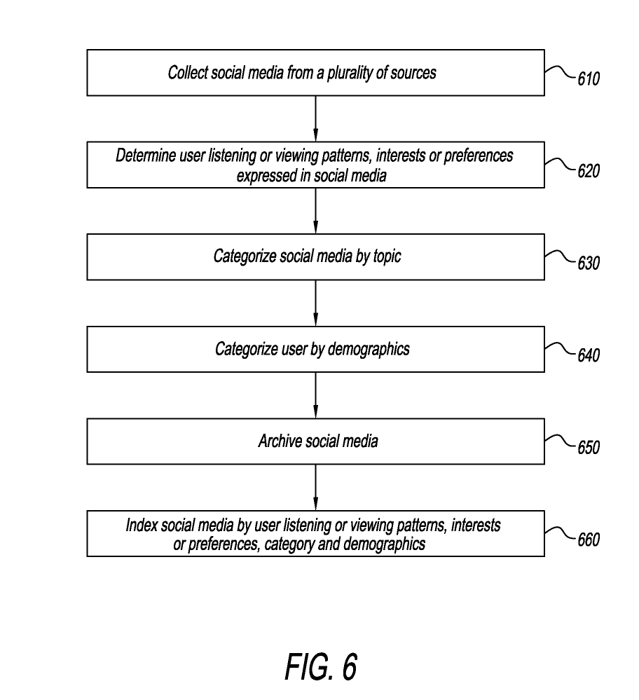

FIG. 6 illustrates a method for aggregating social media. As shown at block 610, a process running on a server collects social media from a plurality of sources. Such sources can include social networking sites, such as FACEBOOK or LINKEDIN, or microblogging sites such as TWITTER. The process can filter the collected social media by keyword or user ID to reduce the volume of such social media. For example, the process can filter tweets based on a specific company such as “XYZ” and/or “ABC,” since a specific company may only be interested in social media posts that relate to that company. In another example, social media can be filtered by topic, for example “network,” “response time” or “DSL”. A data collection module (such as module 502 of FIG. 5) hosted on a social media analysis server performs the processing of collecting social media from a plurality of sources as described with respect to block 610. The processing of block 610 includes parsing the social media to extract entities such as urls, locations, person names, topic tags, user ID, products, and features of products. The processing of block 610 includes estimating the location from which users submitted social media when the location is not expressly given in the social media.

In block 620, a process running on a server analyzes the social media to determine the user's listening or viewing patterns, interests or preferences. The process detects user listening or viewing patterns, interests or preferences in social media by recognizing positive words and negative words. The correlation between a user listening or viewing pattern, interest or preference and a key word can vary by source. A listening/viewing pattern analysis module (such as module 505 of FIG. 5) hosted on a social media analysis server performs the processing described with respect to block 620.

In block 630, a process running on a server analyzes the social media to categorize the media by one or more topics. Such topics can include user listening or viewing patterns, interests or preferences (e.g., “jazz” or “country” music), brand, product type, or product quality. Such topics can be predefined, or the process can determine topics dynamically by consolidating social media posts from multiple users. The process can use such topics to cluster social media posts. The process can assign specific topics a priority or importance. A social data categorization module (such as module 510 of FIG. 5) hosted on a social media analysis server performs the processing described with respect to block 630.

In block 640, a process running on a server analyzes the user posting the social media to categorize users associated with each post by one or more demographic categories. Such categories can include age, income level and interests (e.g., classical music or cross country skiing). Such categories can include user location (e.g., city, state or region). The process can determine such information from user profile data or from the content of social media posts. The process can determine such information by mining a user's social network (e.g., the user's friends on FACEBOOK, and the like). A user categorization module (such as module 515 of FIG. 5) hosted on a social media analysis server performs the processing described with respect to block 640. The processing of block 640 additionally includes determining the influence of individual users in their demographic group.

In block 650, a process running on a server archives the social media to a computer readable medium. The process can store the social media on any type of database known in the art, such as, for example, a relational database. The database can include all, or a subset of the data collected in the operation described above with respect to block 610. For example, the process can only archive data relating to specific entities and/or topics. A data archiving module (such as module 520 of FIG. 5) hosted on a social media analysis server performs the processing described with respect to block 650.

In addition to archiving social media with high precision and recall, the system archives user profiles and the social connections of the users associated with the social media along with the social media. The processing of block 640 collects all such information. Additionally or alternatively, the processing of block 650 includes retrieving the user profiles and social connections of users relating to the archived social media.

In block 660, a process running on a server indexes the archived social media by one or more properties. The process indexes the data to allow for efficient retrieval of social media by its properties. Such properties can include, for example, key words, user listening or viewing patterns, interests or preferences, category, or user demographics. A data indexing module (such as module 530 of FIG. 5) hosted on a social media analysis server performs the processing described with respect to block 660.

In one embodiment, a computing apparatus can correlate, or provide information to facilitate the correlation of, payment card transactions with online listening and viewing activities of media streaming services by the customers. The correlation results are used in predictive models to predict transactions and/or spending patterns based on media listening or viewing patterns, interests or preferences, to make targeted advertisements.

Further, other information can contain, for example, external information (not shown in FIG. 3). Illustrative external information can include, for example, geographic and demographic information. In particular, the external information can include, for example, geographic areas (e.g., metropolitan areas (metropolitan statistical area (MSA), designated market area (DMA), and the like), event venues, and the like). The external information can be categorized, for example, by country, state, zip code, and the like. The geolocations can be clustered (i.e., location clusters) by category, for example, by activities, events, or other categories. As with the social media information, the external information can also be data mined from social media.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific predictive travel pattern profile is retrieved from each of the databases.

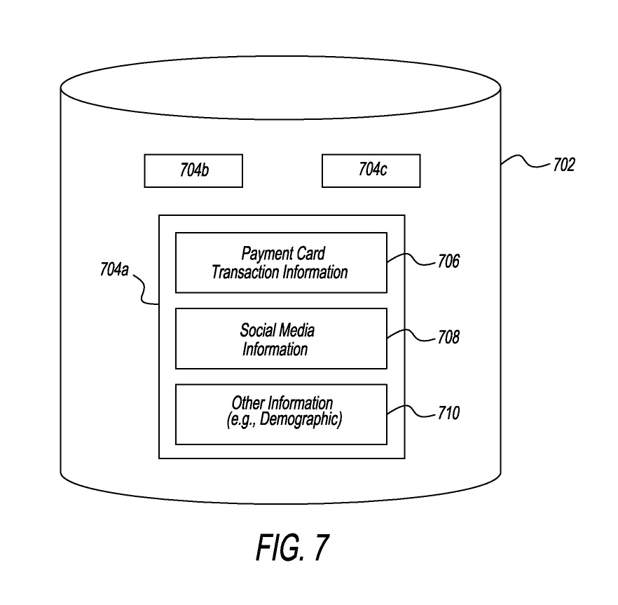

FIG. 7 illustrates an exemplary dataset 702 for the storing, reviewing, and/or analyzing of information used in the systems and methods of this disclosure. The dataset 702 can contain a plurality of entries (e.g., entries 704a, 704b, and 704c).

As described herein with respect to entity 704a, the payment card holder transaction information 706 includes payment card transactions and actual spending. The payment card transaction information 706 can contain, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), payment transaction amount information, and the like.

Also, as described herein, the social media information 708 can include, for example, social media information indicative of one or more media listening or viewing patterns, interests or preferences of the audience of potential acceptors. Illustrative social media information indicative of one or more media listening or viewing patterns, interests or preferences of the audience of potential acceptors includes, for example, information concerning the merchant that is retrieved from TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines. Preferred processes for social media data mining to obtain information regarding consumer listening or viewing patterns, interests or preferences are described herein. Illustrative embodiments of such processes for social media data mining to obtain information indicative of one or more media listening or viewing patterns, interests or preferences are shown in FIGS. 4-6.

The other information 710 includes, for example, geographic, demographic or other suitable information that can be useful in conducting the systems and methods of this disclosure. As with the social media information, the other information 710 can also be data mined from social media.

Algorithms can be employed to determine formulaic descriptions of the integration of the payment card transaction information and the social media information using any of a variety of known mathematical techniques. These formulas, in turn, can be used to derive or generate one or more analyses and updates for identifying associations between the payment card transaction information and the social media information using any of a variety of available trend analysis algorithms. For example, these formulas can be used to analyze the payment card transaction data, the social media information, and the external information to construct one or more definitions of payment card transactions and one or more payment card holder lists by payment card transactions to identify payment card holder overlap, and one or more definitions of payment card transactions, one or more definitions of social media information indicative of one or more media listening or viewing patterns, interests or preferences, and one or more payment card holder lists by payment card transactions and by social media information indicative of one or more media listening or viewing patterns, interests or preferences, to identify payment card holder overlap, and to create one or more groupings of payment card transactions and social media information indicative of one or more media listening or viewing patterns, interests or preferences based on the payment card holder overlap, and one or more datasets to store information relating to the one or more groupings of payment card transactions and social media information indicative of one or more media listening or viewing patterns, interests or preferences of the audience of potential acceptors.

In an embodiment, logic is developed for creating one or more groupings payment card transactions and social media information indicative of one or more media listening or viewing patterns, interests or preferences based on the payment card holder overlap. The logic is applied to a universe of payment card transactions and social media information indicative of one or more media listening or viewing patterns, interests or preferences, to create associations between the payment card transactions and the social media information indicative of one or more media listening or viewing patterns, interests or preferences of the audience of potential acceptors.

In accordance with the method of this disclosure, information that is stored in one or more databases can be retrieved (e.g., by a processor). The information can contain, for example, billing activities attributable to the financial transaction processing entity (e.g., a payment card company) and purchasing and payment activities, including date and time, attributable to the audience of potential acceptors (e.g., payment card holders), social media information indicative of one or more media listening or viewing patterns, interests or preferences of the audience of potential acceptors, demographic (e.g., age and gender), geographic (e.g., zip code and state or country of residence), and the like. Other illustrative information can include, for example, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive behavioral model is retrieved from each of the databases.

In accordance with the method of this disclosure, one or more predictive behavioral models are generated based at least in part on the first set of information and the second set of information. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models can be based on specific criteria.

Predictive behavioral models are generated from the information obtained from each database. The information is analyzed, extracted and correlated by, for example, a financial transaction processing company (e.g., a payment card company), and can include financial account information, social media information, performing statistical analysis on financial account information and social media information, finding correlations between account information, social media information and consumer behaviors, predicting future consumer behaviors based on account information and social media information, relating information on a financial account and a social media website with other financial accounts and social media websites, or any other method of review suitable for the particular application of the data, which will be apparent to persons having skill in the relevant art.

Activities and characteristics attributable to the audience of potential acceptors based on the one or more predictive behavioral models are identified. The audience of potential acceptors has a propensity to carry out certain activities and to exhibit certain characteristics, based on the one or more predictive behavioral models. The activities and characteristics attributable to the audience of potential acceptors and based on the one or more predictive behavioral models are conveyed by the financial transaction processing entity to the entity making the targeted offer. This conveyance enables a targeted offer to be made by the entity to the audience of potential acceptors. The transmittal can be performed by any suitable method as will be apparent to persons having skill in the relevant art.

Predictive behavioral models can be defined based on geographical or demographical information, including but not limited to, age, gender, income, marital status, postal code, income, spending propensity, and familial status. In some embodiments, predictive behavioral models can be defined by a plurality of geographical and/or demographical categories. For example, a predictive behavioral model can be defined for any card holder who engages in purchasing and spending activity and social media website activity.

Predictive behavioral models can also be based on behavioral variables. For example, the financial transaction processing entity database can store information relating to financial transactions. The information can be used to determine an individual's likeliness to spend at a particular date and time. An individual's likeliness to spend can be represented generally, or with respect to a particular industry (e.g., electronics), retailer (e.g., Macy's®), brand (e.g., Apple®), or any other criteria that can be suitable as will be apparent to persons having skill in the relevant art. An individual's behavior can also be based on additional factors, including but not limited to, time, location, and season. For example, a predictive behavioral model can be based on consumers who are likely to spend on electronics during the holiday season, or on sporting goods throughout the year. The factors and behaviors identified can vary widely and can be based on the application of the information.

Behavioral variables can also be applied to generated predictive behavioral models based on the attributes of the entities. For example, a predictive behavioral model of specific geographical and demographical attributes can be analyzed for spending behaviors. Results of the analysis can be assigned to the predictive behavioral models. For example, the predictive behavioral model can reveal that the entities in the predictive behavioral model living and working in Fairfield County, Connecticut have a high spending propensity for electronics or sporting goods during weekdays and are less likely to spend during weekends.

In an embodiment, the information retrieved from each of the databases can be analyzed to determine behavioral information of the audience of potential acceptors. Also, information related to an intention of the audience of potential acceptors can be extracted from the behavioral information. The predictive behavioral models can be based upon the behavioral information of the audience of potential acceptors and the intent of the audience of potential acceptors. The predictive behavioral models can be capable of predicting behavior and intent in the audience of potential acceptors.

Predictive behavioral models can be developed, for example, to examine spend behaviors and create spend associations. A spend association can be a set of spend behaviors that predict another spend behavior. For example, people that tend to purchase jewelry display the following spend behaviors: spend at Macy's®, travel on cruise ships, go to the movie theaters once a month, and so forth.

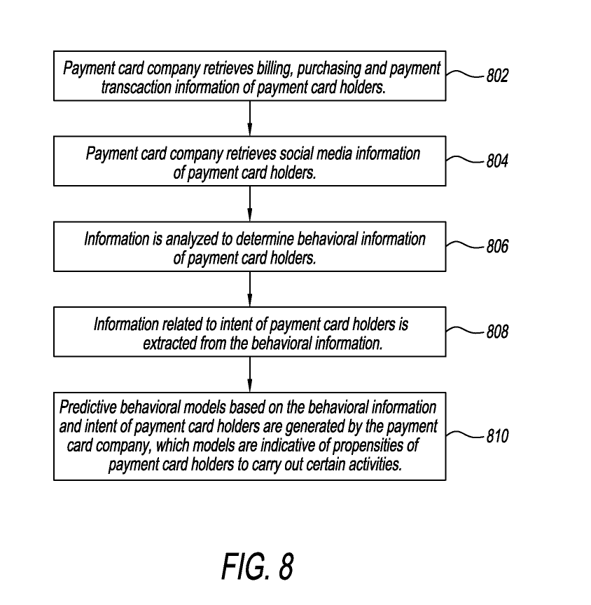

A method for generating one or more predictive behavioral models is an embodiment of this disclosure. Referring to FIG. 8, the method involves a payment card company (part of the payment card company network 150 in FIG. 1) retrieving, from one or more databases, information including activities and characteristics attributable to one or more payment card holders. At 802, the information comprises payment card billing, purchasing and payment transactions, and optionally demographic and/or geographic information. The payment card company also retrieves at 804, from one or more databases, information including social media information attributable to one or more payment card holders. The information at 804 comprises social media information indicative of one or more media listening or viewing patterns, interests or preferences of the audience of potential acceptors, and optionally demographic and/or geographic information. The information is analyzed at 806 to determine behavioral information of the one or more payment card holders. Information related to an intent of the one or more payment card holders is extracted from the behavioral information at 808. One or more predictive behavioral models are generated at 810 based on the behavioral information and intent of the one or more payment card holders. The one or more payment card holders have a propensity to carry out certain activities at certain times based on the one or more predictive behavioral models.

In analyzing information to determine behavioral information, intent (audience) and other payment card member attributes are considered. Developing intent of audiences involves models that predict specific spend behavior at certain times in the future and desirable spend behaviors.

Predictive behavioral models can equate to purchase behaviors. There can be different degrees of predictive behavioral models with the ultimate behavior being a purchase. An example using Macy's® is as follows: an extreme behavior is a consumer purchasing something once a week at Macy's® during weekdays and spending five times what the average customer spends; a medium behavior is a consumer purchasing something at Macy's® once a month during weekdays and spending twice what the average customer spends; and a low behavior is a consumer purchasing something at Macy's® once a year during a weekend and spending what the average customer spends.

There is the potential for numerous predictive behavioral models including, for example, industries (e.g., consumer electronics, QSR), categories (e.g., online spend, cross border), geography spend (e.g., spend in New York City, spend in London), geography residence (e.g., live in New York City, live in Seattle), day/time spend (e.g., weekday spend, lunch time spend), calendar spend (e.g., spend a lot around Christmas, spend a lot on flowers before Valentine's Day), top number of merchants, and the like.

Other card holder attributes part of the information include, for example, geography (e.g., zip code, state or country), and demographics (e.g., age, gender, and the like).

The method further includes conveying to an entity the activities and characteristics attributable to the one or more payment card holders based on the one or more predictive behavioral models, to enable the entity to make a targeted offer to the one or more payment card holders. The one or more predictive behavioral models are capable of predicting behavior and intent in the one or more payment card holders. The one or more payment card holders are people and/or businesses; the activities attributable to the one or more payment card holders are purchasing and spending transactions and media listening and viewing activity associated with the one or more payment card holders; and the characteristics attributable to the one or more payment card holders are demographics and/or geographical characteristics of the one or more payment card holders.

A behavioral propensity score is used for conveying to the entity the activities and characteristics attributable to the one or more payment card holders based on the one or more predictive behavioral models. The behavioral propensity score is indicative of a propensity to exhibit a certain behavior.

Potential acceptor audiences can represent a wide variety of categories and attributes. In one embodiment, potential acceptor audiences can be created based on spending propensity of spending index in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like. Each industry can include a plurality of potential acceptor audiences (e.g., based on location, income groups, and the like).

Potential acceptor audiences can also be based on predictions of future behavior. For instance, a financial transaction processing company can analyze financial account information and behavioral information to predict future behavior of a potential acceptor.

Potential acceptor audiences can also be aligned with other similar potential acceptor audiences. Similar potential acceptor audiences can be determined by similarities in, for example, the audience parameters (e.g., nearby postal codes), or in the entities contained in the predictive behavioral models (e.g., a larger number of card holders common to both audiences). In one embodiment, the financial transaction processing company can create potential acceptor audiences based on received parameters, which can be aligned to audiences created by a third party on the same parameters yet include different entities or behaviors. The process and parameters for the alignment of potential acceptor audiences can be dependent on the application of the audiences, as will be apparent to persons having skill in the relevant art.

A financial transaction processing company can analyze the generated predictive behavioral models (e.g., by analyzing the stored data for each entity comprising the predictive behavioral model) for behavioral information (e.g., spend behaviors and propensities). In some embodiments, the behavioral information can be represented by a behavioral propensity score. Behavioral information can be assigned to each corresponding predictive behavioral model, or can be assigned to an audience of predictive behavioral models.

Predictive behavioral models or behavioral information can be updated or refreshed at a specified time (e.g., on a regular basis or upon request of a party). Updating predictive behavioral models can include updating the entities included in each predictive behavioral model with updated demographic data and/or updated financial data and/or updated social media data. Predictive behavioral models can also be updated by changing the attributes that define each predictive behavioral model, and generating a different set of behaviors. The process for updating behavioral information can depend on the circumstances regarding the need for the information itself.

Although the above methods and processes are disclosed primarily with reference to financial data, social media data and spending behaviors, it will be apparent to persons having skill in the relevant art that the predictive behavioral models can be beneficial in a variety of other applications. Predictive behavioral models can be useful in the evaluation of consumer data that may need to be protected.

For instance, predictive behavioral models can have useful applications in measuring the effectiveness of advertising or other consumer campaigns. A party can desire to discover the effectiveness of a particular advertising campaign in reaching a specific set of consumers.

For example, a consumer electronics store may want to know the effectiveness of an advertising campaign initiated by the store and directed towards male consumers of a specific age and income group. The store can provide the financial transaction processing company with the demographic (e.g., demographical and geographical) data corresponding to the market. The financial transaction processing company can obtain financial transaction data and social media data. The financial transaction processing company can identify predictive behavioral models with corresponding financial transaction data, social media data and demographic data, and summarize relevant spend behaviors for the identified predictive behavioral models. Summary of the relevant spend behaviors (e.g., showing an increase or decrease in spending at the consumer electronic store at particular times and dates) for each predictive behavioral model (e.g., including the predictive behavioral models of ideal consumers) can be provided to the consumer electronics store.

Predictive behavioral model data can also be combined or matched with other sources of data. For example, other transaction processing agencies, advertising firms, advertising networks, publishers, and the like can provide information on consumer groupings of their own. The financial transaction processing company can link or match the received consumer groupings, such as by matching groupings to generated predictive behavioral models based on geographical or demographical data.

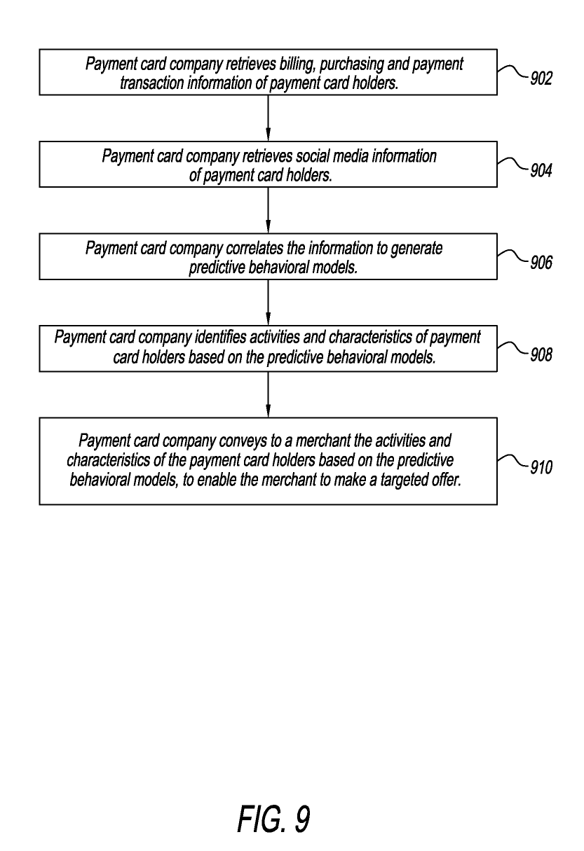

FIG. 9 illustrates an exemplary method for making a targeted offer by an entity to an audience of potential acceptors. At step 902, a payment card company (part of the payment card company network 150 in FIG. 1) retrieves, from one or more databases, information including activities and characteristics attributable to one or more payment card holders. The information at 902 includes payment card billing, purchasing and payment transactions, and optionally demographic and/or geographic information. The payment card company also retrieves, from one or more databases, at 904 information including social media information attributable to one or more payment card holders. The information at 904 includes social media information indicative of one or more media listening or viewing patterns, interests or preferences of the audience of potential acceptors, and optionally demographic and/or geographic information.

The payment card company analyzes the first set of information and second set of information to determine behavioral information of the audience of potential acceptors. The payment card company extracts information related to intent of the audience of potential acceptors from the behavioral information.

In step 906, based on at least one of selected activities criteria and selected characteristics criteria from the first set of information and second set of information, including behavioral information and intent of the audience of potential acceptors, a plurality of predictive behavioral models are generated. The payment card company generates predictive behavioral models based on the purchasing and payment activity information and social media information at 906, and identifies activities and characteristics attributable to potential purchasers based on the predictive behavioral models at 908. Activities and characteristics attributable to the audience of potential acceptors are identified at 908 based on the one or more predictive behavioral models. The audience of potential acceptors has a propensity to carry out certain activities and to exhibit certain characteristics based on the one or more predictive behavioral models.

The activities and characteristics attributable to the audience of potential acceptors based on the one or more predictive behavioral models are conveyed to an entity at 910, to enable the entity, such as a merchant, to make a targeted offer to the audience of potential acceptors. In an embodiment, the payment card company conveys to the entity at 910 a behavioral propensity score based on the predictive behavioral models. The score is indicative of a propensity of a potential purchaser to exhibit a certain behavior.

One example of a predictive behavioral model is as follows: live in the following zip codes AND engage in listening or viewing using an online media streaming service AND purchase consumer electronics resulting from advertisements during the listening or viewing time, and the like. Another example of a predictive behavioral model is as follows: between the ages of 25-35 AND engage in listening or viewing using an online media streaming service AND purchase sporting goods resulting from advertisements during the listening or viewing time, and the like.

At step 910, the predictive behavioral models are used to predict behavior and intent in an audience of potential acceptors (e.g., the above predictive behavioral model examples are used to predict individuals likely to purchase consumer electronics or sporting goods in the next week). The entity executes promotions to targeted potential purchasers through a media streaming service. Illustrative media streaming services include, for example, PANDORA, SLACKER, SPOTIFY, and the like.

The system and method of this disclosure can be utilized to provide items of media content to users. Additionally, in some embodiments, the system and method can be used to provide audio and video content simultaneously to a user or device of a user, without interrupting a flow of programming. Typically, internet radio services generally offer only audio streams of programming. Modern audiences are accustomed to having multimedia options available, which in the case of music generally means the addition of music videos.

In an embodiment, the entity provides feedback to the payment card company to enable the payment card company to monitor and track impact of targeted offers. This “closed loop” system allows an entity to track advertising campaigns, measure efficiency of the targeting, and make any improvements for the next round of campaigns.

One or more algorithms can be employed to determine formulaic descriptions of the assembly of the payment card holder information including payment card billing, purchasing and payment transactions, social media information, and optionally demographic and/or geographic information, using any of a variety of known mathematical techniques. These formulas in turn can be used to derive or generate one or more predictive behavioral models using any of a variety of available trend analysis algorithms.

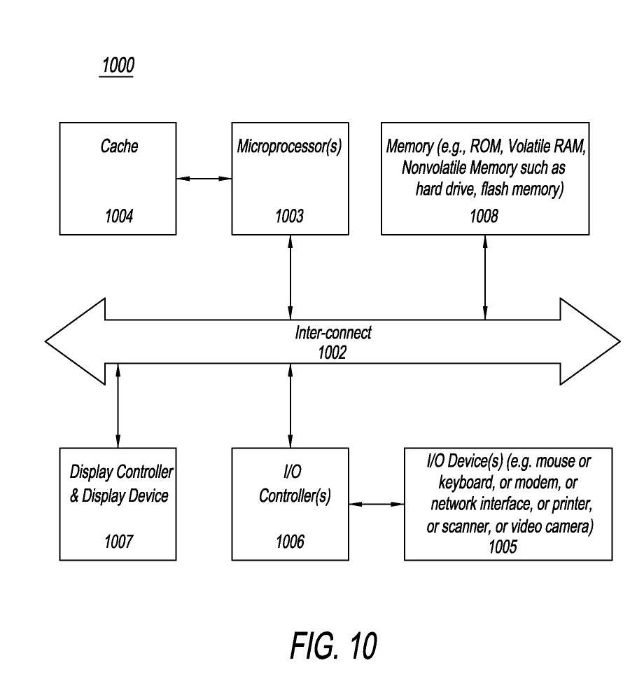

FIG. 10 shows a data processing system 1000 that can be used in various embodiments of social media data mining. While FIG. 10 illustrates various components of a computer system, it is not intended to represent any particular architecture or manner of interconnecting the components. Other systems that have fewer or more components can also be used. One or more data processing systems, such as that shown in 1000 of FIG. 10, implement the social media analysis servers 500 shown in FIGS. 4 and 5. A data processing system, such as that shown in 1000 of FIG. 10, implements each of the modules 502-540 of the social media analysis server 500 of FIG. 5, where each of the modules includes computer-executable instructions stored on the system's memory 1008, such instructions being executed by the system's microprocessor 1003. Other configurations are possible, as will be readily apparent to those skilled in the art.

In FIG. 10, the data processing system 1000 includes an inter-connect 1002 (e.g., bus and system core logic), which interconnects a microprocessor(s) 1003 and memory 1008. The microprocessor 1003 is coupled to cache memory 1004 in the example of FIG. 10.

The inter-connect 1002 interconnects the microprocessor(s) 1003 and the memory 1008 together and also interconnects them to a display controller and display device 1007 and to peripheral devices, such as input/output (I/O) devices 1005, through an input/output controller(s) 1006. Typical I/O devices include mice, keyboards, modems, network interfaces, printers, scanners, video cameras and other devices that are well known in the art.

The inter-connect 1002 can include one or more buses connected to one another through various bridges, controllers and/or adapters. The I/O controller 1006 includes a USB (Universal Serial Bus) adapter for controlling USB peripherals, and/or an IEEE-1394 bus adapter for controlling IEEE-1394 peripherals.

The memory 1008 can include ROM (Read Only Memory), and volatile RAM (Random Access Memory) and non-volatile memory, such as hard drive, flash memory, and the like.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system that maintains data even after power is removed from the system. The non-volatile memory can also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

The social media analysis servers 500 are implemented using one or more data processing systems as illustrated in FIG. 10. In some embodiments, one or more servers of the system illustrated in FIG. 10 are replaced with the service of a peer to peer network or a cloud configuration of a plurality of data processing systems, or a network of distributed computing systems. The peer to peer network, or cloud based server system, can be collectively viewed as a server data processing system.

Embodiments of this disclosure can be implemented via the microprocessor(s) 1003 and/or the memory 1008. For example, the functionalities described above can be partially implemented via hardware logic in the microprocessor(s) 1003 and partially using the instructions stored in the memory 1008. Some embodiments are implemented using the microprocessor(s) 1003 without additional instructions stored in the memory 1008. Some embodiments are implemented using the instructions stored in the memory 1008 for execution by one or more general purpose microprocessor(s) 1003. Thus, this disclosure is not limited to a specific configuration of hardware and/or software.

Where methods described above indicate certain events occurring in certain orders, the ordering of certain events can be modified. Moreover, while a process depicted as a flowchart, block diagram, or the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

It should be understood that the present disclosure includes various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method for making a targeted offer by an entity to an audience of potential acceptors using a media streaming service, the method comprising:
retrieving, from one or more databases, a first set of information including purchasing and payment activity information attributable to the audience of potential acceptors;
retrieving from the one or more databases, a second set of information including social media information indicative of one or more media listening or viewing patterns, interests or preferences of the audience of potential acceptors;
correlating the first set of information with the second set of information to generate one or more predictive behavioral models;
identifying activities and characteristics attributable to the audience of potential acceptors based on the one or more predictive behavioral models; and
conveying to the entity said activities and characteristics attributable to the audience of potential acceptors based on the one or more predictive behavioral models, to enable the entity to make a targeted offer to the audience of potential acceptors using the media streaming service.

2. The method of claim 1, wherein said correlating comprises:
analyzing the first set of information and the second set of information to determine behavioral information of the audience of potential acceptors; and
extracting information related to an intent of the audience of potential acceptors from the behavioral information.

3. The method of claim 2, wherein the one or more predictive behavioral models are based upon the behavioral information of the audience of potential acceptors and the intent of the audience of potential acceptors.

4. The method of claim 1, wherein the audience of potential acceptors are people and/or businesses, wherein the activities attributable to the audience of potential acceptors are purchasing and spending transactions and media listening and viewing, and wherein the characteristics attributable to the audience of potential acceptors are demographics and/or geographical characteristics.

5. The method of claim 1, wherein the first set of information comprises payment card billing, purchasing, spending and payment transactions by the audience of potential acceptors, and optionally demographic and/or geographic information.

6. The method of claim 1, wherein the second set of information comprises social media information retrieved from one or more sites selected from the group consisting of TWITTER, FACEBOOK, FOURSQUARE, GOOGLE+, YELP, AMAZON.COM customer reviews, FOURSQUARE, PINTEREST, PATCH.COM, ANGIESLIST.COM, and EPINIONS.COM, and optionally demographic and/or geographic information.

7. The method of claim 1, wherein the second set of information is generated by:
collecting, using a computing device, a plurality of social media posts relating to one or more media listening or viewing patterns, interests or preferences of the audience of potential acceptors; and
analyzing, using the computing device, the one or more media listening or viewing patterns, interests or preferences of the audience of potential acceptors expressed in each of the plurality of social media posts.

8. The method of claim 1, wherein the media streaming service comprises an audio or video streaming service.

9. The method of claim 1, wherein the audience of potential acceptors comprise one or more payment card holders.

10. The method of claim 1, further comprising:
tracking and measuring impact of the targeted offer based at least in part on purchasing and payment activities attributable to the audience of potential acceptors, after the targeted offer has been made.

11. The method of claim 1, wherein the entity comprises one or more merchant entities.

12. A system for making a targeted offer by an entity to an audience of potential acceptors using a media streaming service, the system comprising:
one or more databases configured to store a first set of information including purchasing and payment activity information attributable to the audience of potential acceptors;
one or more databases configured to store a second set of information including social media information indicative of one or more media listening or viewing patterns, interests or preferences of the audience of potential acceptors;
a processor configured to:
correlate the first set of information with the second set of information to generate one or more predictive behavioral models; and
identify activities and characteristics attributable to the audience of potential acceptors based on the one or more predictive behavioral models; and
a device for conveying to the entity said activities and characteristics attributable to the audience of potential acceptors based on the one or more predictive behavioral models, to enable the entity to make a targeted offer to the audience of potential acceptors using the media streaming service.

13. The system of claim 12, wherein the processor is configured to:
analyze the first set of information and the second set of information to determine behavioral information of the audience of potential acceptors; and
extract information related to an intent of the audience of potential acceptors from the behavioral information.

14. The system of claim 13, wherein the one or more predictive behavioral models are based upon the behavioral information of the audience of potential acceptors and the intent of the audience of potential acceptors.

15. The system of claim 12, wherein the audience of potential acceptors are people and/or businesses, wherein the activities attributable to the audience of potential acceptors are purchasing and spending transactions and media listening or viewing, and wherein the characteristics attributable to the audience of potential acceptors are demographics and/or geographical characteristics.

16. The system of claim 12, wherein the first set of information comprises payment card billing, purchasing, spending and payment transactions by the audience of potential acceptors, and optionally demographic and/or geographic information.

17. The system of claim 12, wherein the second set of information comprises social media information retrieved from one or more sites selected from the group consisting of TWITTER, FACEBOOK, FOURSQUARE, GOOGLE+, YELP, AMAZON.COM customer reviews, FOURSQUARE, PINTEREST, PATCH.COM, ANGIESLIST.COM, and EPINIONS.COM, and optionally demographic and/or geographic information.

18. The system of claim 12, wherein the second set of information is generated by:
collecting, using a computing device, a plurality of social media posts relating to one or more media listening or viewing patterns, interests or preferences of the audience of potential acceptors; and
analyzing, using the computing device, the one or more media listening or viewing patterns, interests or preferences of the audience of potential acceptors expressed in each of the plurality of social media posts.

19. The system of claim 12, wherein the processor is configured to:
track and measure impact of the targeted offer based at least in part on purchasing and payment activities attributable to the audience of potential acceptors, after the targeted offer has been made.

20. A method for generating one or more predictive behavioral models, the method comprising:
retrieving, from one or more databases, a first set of information including purchasing and payment activity information attributable to the audience of potential acceptors;
retrieving from the one or more databases, a second set of information including social media information indicative of one or more media listening or viewing patterns, interests or preferences of the audience of potential acceptors;
analyzing the first set of information and the second set of information to determine behavioral information of the audience of potential acceptors;
extracting information related to an intent of the audience of potential acceptors from the behavioral information; and
generating one or more predictive behavioral models based on the behavioral information and intent of the audience of potential acceptors, wherein the audience of potential acceptors have a propensity to carry out certain activities based on the one or more predictive behavioral models.

21. The method of claim 20, further comprising:
conveying to an entity one or more activities and characteristics attributable to the audience of potential acceptors based on the one or more predictive behavioral models, to enable the entity to make a targeted offer to the audience of potential acceptors using a media streaming service.

22. The method of claim 20, wherein the one or more predictive behavioral models are capable of predicting behavior and intent of the audience of potential acceptors.
